(19) United States
(12) Patent Application Publication
(10) Pub. No.: US 2023/0087567 A1
(43) Pub. Date: Mar. 23, 2023

(54) OPTICAL CIRCUIT WITH LENS AT SUBSTRATE EDGE

(71) Applicant: Intel Corporation, Santa Clara, CA (US)

(72) Inventors: Eric J.M. Moret, Beaverton, OR (US); Pooya Tadayon, Portland, OR (US)

(21) Appl. No.: 17/480,420

(22) Filed: Sep. 21, 2021

(51) Int. Cl. G02B 6/30

(52) U.S. Cl. CPC G02B 6/30

(57) ABSTRACT

In an optical circuit, a substrate can have a substrate top surface, a substrate bottom surface, and a substrate edge surface that extends around at least a portion of a perimeter of the substrate. A photonic integrated circuit (PIC) can be attached to the substrate. The PIC can have a PIC optical port that is configured to accept or emit an optical beam along a PIC optical axis. A lens can be located at the substrate edge surface. The substrate can include an optical path that extends through the substrate from a first substrate optical port that is aligned with the PIC optical axis to a second substrate optical port that faces the lens, such that an optical beam emergent from the PIC optical port can traverse the optical path and pass through the lens to emerge substantially parallel to the substrate top surface.

### TECHNICAL FIELD

Embodiments described herein generally relate to an optical circuit.

### BACKGROUND

A photonic integrated circuit (PIC) can produce light or receive light. For example, a PIC can receive electrical power and can produce laser light at a specified wavelength in response to the received electrical power. The electrical power can optionally have a time-varying current or voltage, such as to encode a data signal onto the produced laser light. In another example, a PIC can receive light at a specified wavelength, can direct the received light onto a sensor, and can produce a current or voltage in response to the received light. The received light can optionally have a time-varying power level, such as corresponding to an encoded data signal on the received light, such that the PIC can produce a time-varying current or voltage that corresponds to the encoded data signal.

The PIC can operate within an optical circuit. For example, light can be coupled from the PIC into a fiber or can be coupled from a fiber into the PIC. Efficient coupling (e.g., coupling that includes an optical loss at or below a specified level) can involve relatively tight mechanical tolerances. For example, there may be relatively tight positional and/or angular tolerances on the PIC, on a fiber connector, and/or on any intervening optical elements between the PIC and the fiber connector.

There is ongoing effort to achieve efficient coupling between the PIC and the fiber. It is desired to have an optical circuit that addresses these concerns, and other technical challenges.

### BRIEF DESCRIPTION OF THE DRAWINGS

FIG. 1 shows a side view of an example of an optical circuit, in accordance with some embodiments.

FIG. 2 shows a side view of a portion of another example of an optical circuit, in accordance with some embodiments.

FIG. 3 shows a flow chart of an example of a method for assembling an optical circuit, in accordance with some embodiments.

FIG. 4 shows a system level diagram, depicting an example of an electronic device (e.g., system) that may include an optical circuit and/or methods described above.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

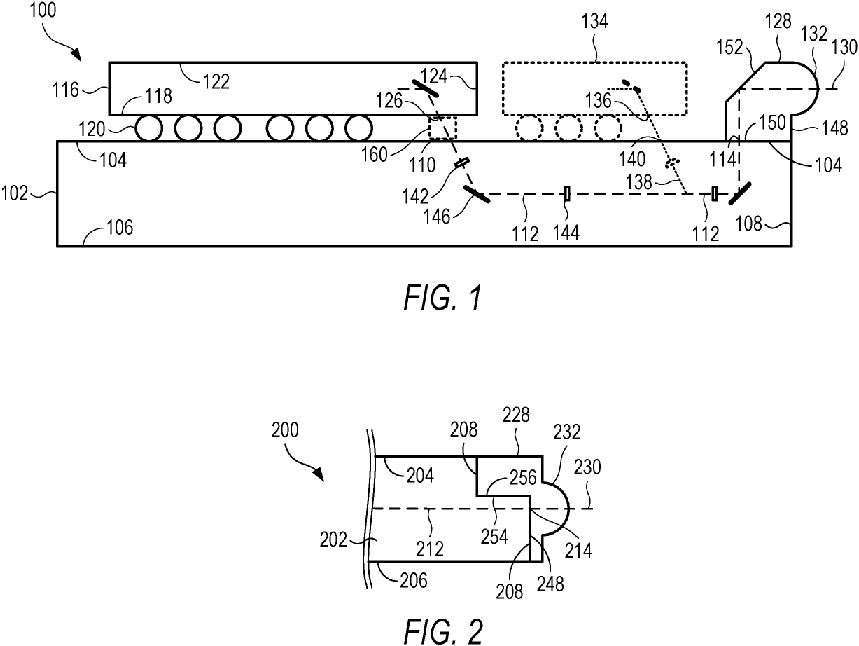

FIG. 1 shows a side view of an example of an optical circuit 100, in accordance with some embodiments. The optical circuit 100 can include a substrate 102, a photonic integrated circuit (PIC) 116 attached to the substrate 102, and a lens 128 located at, near, or on an edge of the substrate 102. The substrate 102 can include an optical path 112 that extends through the substrate 102 between the PIC 116 and the lens 128, such that an optical beam 130 emergent from the PIC 116 can traverse the optical path 112 and pass through the lens 128 to emerge substantially parallel to the substrate top surface 104 and/or the substrate bottom surface 106. Such a geometry can rely on wafer-based processing, which can have positional tolerances that are tight enough to allow the optical components of the optical circuit 100 to be located passively (e.g., without moving any components in response to a feedback-based error signal). The optical circuit 100, along with the wafer-based processing that produces the optical circuit 100, can provide an accurately located optical beam that is suitable for use with a mechanical connector. The configuration of FIG. 1 is but one example of an optical circuit 100; other configurations can also be used.

The optical circuit 100 can include a substrate 102. In some examples, the substrate 102 can be formed from a rigid material, such as for providing mechanical support for circuitry chips and other elements of the optical circuit 100. In some examples, the substrate 102 can include one or more materials that are fully or at least partially transparent at one or more wavelengths. For example, the substrate 102 can be formed from silicon, glass, polycarbonate, or other suitable materials. In some examples, the substrate 102 can be formed from a silicate-based glass (lithium-silicate, borosilicate, aluminum silicate, etc.). In some examples, the substrate is a glass substrate made from lower quality glass (e.g., glass made with soda lime), or a glass substrate made from a higher quality glass (e.g., glass made with fused silica or quartz). In some examples, the substrate 102 can be formed from one or more materials that can be processed at a wafer level, such as by photolithography or other suitable techniques. Wafer-level processing techniques such as photolithography can allow placement of features on or within the substrate 102 with placement tolerances that can be significantly smaller than the wavelength. Further, the processing techniques can allow integration of additional optical components within or on the substrate 102, such as lenses, mirrors, and others. Examples of the additional optical components are discussed in detail below.

The substrate 102 can have a substrate top surface 104. In some examples, the substrate top surface 104 can be referred to as a substrate front surface. It will be understood that designations such as “front” and “top” are but convenient descriptors for particular sides of the substrate 102. For example, a substrate bottom surface 106 may be located opposite the substrate top surface 104, and a substrate back surface may be located opposite the substrate front surface. A substrate edge surface 108 can extend around at least a portion of a perimeter of the substrate 102 between the substrate top surface 104 and the substrate bottom surface 106. These descriptors are included merely for convenience and ease in reference, and do not imply an absolute direction to any of the described elements.

The substrate 102 can include a first substrate optical port 110. The first substrate optical port 110 can align to a corresponding port on the PIC 116, so that when the optical circuit 100 is assembled, light can propagate between the substrate 102 and the PIC 116 with relatively high efficiency (e.g., with a coupling loss that is less than or equal to a loss threshold, such as 2 dB, 1 dB, 0.5 dB, 0.2 dB, 0.1 dB, or other suitable value).

The substrate 102 can include an optical path 112 that extends through the substrate 102. In some examples, the optical path 112 can be formed as a volume within an elongated waveguide within the substrate 102. For example, such a waveguide can be formed as an air-filled passage (having a refractive index close to unity) extending within the material of the substrate 102, the material having a refractive index greater than that of the air-filled passage. As another example, the waveguide can be formed as a passage being filled with a solid material (such as glass) having a refractive index less than that of the substrate 102 (such as silicon). The waveguide can optionally include bends, such that the waveguide can extend to any specified volume within the substrate 102.

The optical path 112 can include interactions with one or more optical components that can be formed integrally with the substrate 102. Any or all of the optical components can be formed by techniques such as ion exchange, laser direct writing, etching, and others. For example, the substrate 102 can include a lens 142 integral with the substrate 102. In some examples, the lens 142 can collimate a beam emitted from the PIC 116 along the PIC optical axis when the PIC 116 is attached to the substrate 102. In some examples, the lens 142 can focus a beam directed toward the PIC 116 along the PIC optical axis when the PIC 116 is attached to the substrate 102. As another example, the substrate 102 can include an isolator 144 integral with the substrate 102. In some examples, when the PIC 116 is attached to the substrate 102, the isolator 144 can pass light that travels in a first direction along the optical path 112 and can block light that travels in a second direction opposite in the first direction along the optical path 112. As another example, the substrate 102 can include a mirror 146 integral with the substrate 102. The mirror 146 can reflect light along the optical path 112 within the substrate 102. Because the optical components can be formed integrally with the substrate 102 (e.g., such as by using semiconductor processes, such as photolithography), the optical components can be formed and located in high volumes (such as, as a wafer level) and can be formed and located with relatively high precision. For example, the location tolerances for photolithography-based features can be tighter than for comparable pick-and-place features. In other words, by forming the optical components at a wafer-level, the optical components can be manufactured more precisely and less costly than comparable components that are manufactured separately and are mechanically (e.g., robotically) placed. The lens, isolator, and mirror are but three examples of optical components that can be integral with the substrate 102; other suitable components can also be used.

The optical path 112 can extend through the substrate 102 from a first substrate optical port 110 to a second substrate optical port 114. The first substrate optical port 110 can direct light into the PIC via a PIC optical port or can receive light emitted from the PIC via the PIC optical port. The second substrate optical port 114 can direct light into the lens or can receive light from the lens. The PIC, the first substrate optical port 110, the second substrate optical port 114, the optical path 112, and the lens can be positioned such that an optical beam emergent from the PIC optical port traverses the optical path 112 and passes through the lens to emerge substantially parallel to the substrate top surface 104.

The optical circuit 100 can include a photonic integrated circuit (PIC) 116 that is attached to the substrate 102, such as on the substrate top surface 104. During assembly of the optical circuit 100, the PIC 116 can be placed onto the substrate 102, such as in the substrate top surface 104. In some examples, the PIC 116 can be placed using high-accuracy pick-and-place machinery. In some examples, the PIC 116 can self-align to the substrate 102 (using a self-alignment technique discussed in detail below). The PIC 116 can be fastened in place with respect to the substrate 102. Because the self-alignment technique can be relatively robust and can provide alignment precision that is typically a fraction of the wavelength of light used by the PIC 116, the optical elements in the optical path 112 can be included with the substrate 102, so that the PIC 116 can lack additional optical elements. For example, the PIC 116 can lack a lens, an isolator, a mirror, and/or other optical elements.

The PIC 116 can have a PIC bottom surface 118 that can electrically contact the substrate top surface 104. The electrical connection 120 can include one or volumes of an electrically conductive material, such as solder. The volumes can be shaped as balls, spheres, blobs, or other suitable shapes. During assembly, the electrically conductive material can be in liquid form. After the PIC 116 has been placed in a suitable location with respect to the substrate 102, the PIC 116 can be fastened in place, such as by solidifying the electrically conductive volumes. In some examples, the electrically conductive material can additionally function as surface tension self-alignment features (as explained in detail below). As an alternative, the PIC 116 need not directly connect electrically to the substrate 102 but can instead connect electrically to one or more intermediate chips or circuits, which can in turn connect electrically to the substrate 102.

The PIC 116 can have a PIC top surface 122, opposite the PIC bottom surface 118. The PIC top surface 122 can optionally lack electrical connections. The PIC top surface 122 can optionally be used to help dissipate heat generated by the PIC 116.

The PIC 116 can have a PIC edge surface 124 that extends around at least a portion of a perimeter of the PIC 116 between the PIC bottom surface 118 and the PIC top surface 122. In FIG. 1, the PIC edge surface 124 is shown as being orthogonal to the PIC front surface 118 and/or orthogonal to the PIC back surface 122. The PIC edge surface 124 can alternatively include one or more inclined portions, curved portions, bevels, steps, and/or ridges. Other configurations can also be used.

The PIC 116 can have a PIC optical port 126 located on an external-facing surface of the PIC 116, such as the PIC bottom surface 118 (as in the configuration of FIG. 1), the PIC top surface 122, or the PIC edge surface 124. The PIC optical port 126 can accept or emit an optical beam along a PIC optical axis. The PIC optical axis can be aligned with the first substrate optical port 110 when the PIC 116 is attached to the substrate 102. The optical beam can be collimated, diverging, or converging as it passes through the PIC optical port 126. The PIC optical port 126 can be formed using wafer-level techniques, such as photolithography, such that the location of the PIC optical port 126 can be controlled relatively precisely with respect to self-alignment features, discussed below.

The PIC bottom surface 118 can include a first plurality of surface tension self-alignment features, such as the electrically conductive volumes. The substrate top surface 104 can include a second plurality of surface tension self-alignment features having locations that correspond to the first plurality of surface tension self-alignment features. The first plurality of surface tension self-alignment features can self-align via surface tension to the second plurality of surface tension self-alignment features when the first plurality of surface tension self-alignment features is placed in contact with the second plurality of surface tension self-alignment features. In some examples, such as the configuration of FIG. 1, the first plurality of surface tension self-alignment features and the second plurality of surface tension self-alignment features can also be used to electrically connect the PIC 116 to the substrate 102. In other examples, the first plurality of surface tension self-alignment features and the second plurality of surface tension self-alignment features may not be used for electrical connectivity between the PIC 116 and the substrate 102.

The first plurality of surface tension self-alignment features and the second plurality of surface tension self-alignment features can be in a liquid state under a specified physical condition. For example, some or all of the surface tension self-alignment features can be delivered in a solid state, then heated to melt the surface tension self-alignment features. As another example, some or all of the surface tension self-alignment features can be delivered in a liquid state, to remain in the liquid state during self-alignment. As still another example, some or all of the surface tension self-alignment features can be delivered in a liquid state, cooled to a solid state, and melted to return to the liquid state during self-alignment.

In some examples, the self-alignment can help provide relatively tight positional tolerances, for positioning in the plane parallel to the substrate top surface 104. In some of these examples, the self-alignment can optionally provide relatively loose positional tolerances (e.g., looser than in the plane parallel to the substrate top surface 104) in the direction orthogonal to the substrate top surface 104. The different positional tolerances in different directions can be accommodated by selecting a suitable beam size and a suitable beam divergence (e.g., a degree of collimation) of the optical beam emergent from or entering the PIC optical port 126.

The optical circuit 100 can include a lens 128. The lens 128 can be located at, near, or on the substrate edge surface 108. The optical path 112 can extend through the substrate 102 from the first substrate optical port 110, which is aligned with the PIC optical axis, to the second substrate optical port 114, which faces the lens 128. The optical elements and the optical path 112 can be arranged such that an optical beam 130 emergent from the PIC optical port 126 traverses the optical path 112 and passes through the lens 128 to emerge substantially parallel to the substrate top surface 104. Emergence of the optical beam 130 in this manner can provide a beneficial interface for using a mechanical connector (or other suitable connector) to direct the optical beam into or out of the optical circuit 100.

The lens 128 can have a curved surface 132. The curved surface 132 can be convex, so that the curved surface 132 can have positive optical power. The curved surface 132 can have a radius of curvature selected to collimate light that emerges from the optical path 112 of the substrate 102 or focus collimated light into the optical path 112 of the substrate 102. For these configurations, the light in free space (e.g., directly adjacent to the lens 128) can be collimated. Alternatively, the light in free space can be converging or diverging. The curved surface 132 can have a central axis that is substantially parallel to the substrate top surface 104, which can help ensure that the optical beam passing through the lens 128 can propagate in an angular distribution that is centered along a direction that is parallel or substantially parallel to the substrate top surface 104. In some examples, a diffractive element can be used in addition to or in place of the curved surface 132. In some examples, the lens 128 can include a gradient index material, and can be formed with or without a curved surface 132. In some examples, the substrate 102 can include a substrate material, such as silicon, and the lens 128 can include a lens material different from the substrate material, such as glass. Other suitable optically transparent materials (e.g., materials that are transparent or substantially transparent at one or more wavelengths used by the PIC 116) can also be used.

In some examples, the lens 128 can be grown on the substrate 102 or fabricated in an integral manner with the substrate 102. In other examples, the lens 128 can be manufactured separately from the substrate 102 and attached to the substrate 102. For both of these cases, the optical circuit 100 can take advantage of wafer-level processing to ensure that the lens 128 can be positioned or manufactured with relatively tight tolerances with respect to the optical path 112 and the substrate 102. Such tight tolerances can help couple the optical beam into a suitable connector (not shown) for interfacing with systems or networks outside the optical circuit 100.

An optional index-matching material 160 can be disposed between the first substrate optical port 110 and the PIC optical port 136. The index-matching material 160 can help reduce reflections at an interface between the PIC 116 and the substrate 102. As an alternative to free-space propagation of light, the first substrate optical port 110 and the PIC optical port 136 (or, optionally, extended portions of respective light guides in the PIC 116 and the substrate 102) can be positioned close together to provide evanescent coupling between the PIC 116 and the substrate 102.

An optional second PIC 134 can be attached to the substrate 102. The second PIC 134 can have a second PIC optical port 136 that is configured to accept or emit a second optical beam along a second PIC optical axis. The substrate 102 can further include an optical path branch 138 that extends through the substrate 102 from a third substrate optical port 140 aligned with the second PIC optical axis to the optical path 112, such that a second optical beam emergent from the second PIC optical port 136 traverses the optical path branch 138 and a portion of the optical path 112 and passes through the lens 128 to emerge substantially parallel to a plane of the substrate top surface 104. The optical circuit 100 can optionally include additional PICs as needed. By including a branched optical path 112 inside the substrate 102, the optical circuit 100 can use a single connector to connect to multiple PICs, which can use less space on the substrate 102 than a comparable circuit that uses a connector for each PIC.

FIGS. 1 and 2 show two examples for locations of the lens 128. In the configuration of FIG. 1, described presently, the lens 128 is positioned on the substrate top surface 104 and positioned near or at the substrate edge surface 108, and the second substrate optical port 114 is located on the substrate top surface 104. In the configuration of FIG. 2, described below, the lens is positioned on the substrate edge surface and the second substrate optical port is located on the substrate edge surface.

In the configuration of FIG. 1, the lens 128 is located on the substrate top surface 104 proximate the substrate edge surface 108. In some examples, the lens 128 can include a lateral surface 148 that is parallel to the substrate edge surface 108 and, optionally, coplanar with the substrate edge surface 108. In some examples, the lens 128 can include a lens portion that extends radially outward beyond the substrate edge surface 108.

The lens 128 can include a lens reference surface 150 that contacts the substrate top surface 104. In some examples, the lens reference surface 150 can be planar, and can contact the substrate top surface 104 over a contact area. In some examples, the optical beam emergent from the PIC optical port can traverse the optical path 112 and can enter the lens 128 through the lens reference surface 150 and, optionally, through the contact area. In some examples, the substrate top surface 104 can define a top surface plane, and the lens 128 can be located on only one side of the top surface plane.

The lens 128 can include a facet 152 that is configured to reflect light inside the lens 128 via total internal reflection. Such a facet 152 can be located to direct the optical beam 130 out of the lens 128 at a specified height above the substrate top surface 104. The facet 152 can be oriented at 45 degrees with respect to the substrate top surface 104, or at another suitable orientation.

FIG. 2 shows a side view of a portion of another example of an optical circuit 200, in accordance with some embodiments. Compared with the configuration of FIG. 1, the lens 228 in FIG. 2 is positioned on the substrate edge surface 208 (instead of on the substrate top surface 104 as in FIG. 1) and the second substrate optical port 214 in FIG. 2 is located on the substrate edge surface 208 (instead of on the substrate top surface 104 as in FIG. 1). The optical elements and the optical path 212 can be arranged such that an optical beam 230 emergent from the PIC optical port traverses the optical path 212 and passes through the lens 228 to emerge substantially parallel to the substrate top surface 104. Elements of the optical circuit 200 that are not shown in FIG. 2 are understood to be similar in construction and function as the corresponding elements of the optical circuit 100 of FIG. 1.

The lens 228 can have a curved surface 232. In some examples, the curved surface 232 can have a central axis that is collinear with at least a portion of the optical path 212.

The lens 228 can be located on the substrate edge surface 208. In some examples, the lens 228 can lie entirely along the substrate edge surface 208 without protruding beyond a thickness of the substrate 202. For example, the substrate top surface 204 can define a top surface plane, the substrate bottom surface 206 can define a bottom surface plane, and the lens 228 can be located only between the top surface plane and the bottom surface plane.

The substrate edge surface 208 can include a substrate ledge 254 that can be parallel to the substrate top surface 204. The lens 228 can include a corresponding lens reference surface 256 that contacts the substrate ledge 254. The substrate ledge 254 can be formed by wafer-level techniques and can therefore have a location and orientation with relatively tight positional and angular tolerances. In some examples, the substrate top surface 204 can define a top surface plane, the substrate bottom surface 206 can define a bottom surface plane, and the substrate ledge 254 can be located between the top surface plane and the bottom surface plane.

In some examples, the lens 228 can be grown on the substrate 202 or fabricated in an integral manner with the substrate 202. In other examples, the lens 228 can be manufactured separate from the substrate 202 and attached to the substrate 202. For both of these cases, the optical circuit 200 can take advantage of wafer-level processing to ensure that the lens can be positioned or manufactured with relatively tight tolerances with respect to the optical path 212 and the substrate 202. Such tight tolerances can help couple the optical beam into a suitable connector (not shown) for interfacing with systems or networks outside the optical circuit 200.

In some examples, the lens 228 can include a lateral surface 248 that is parallel to the substrate edge surface 208 and, optionally, coplanar with the substrate edge surface 208. In some examples, the lens 228 can include a lens portion that extends radially outward beyond the substrate edge surface 208.

In the examples shown in FIGS. 1 and 2, the PIC 116 can interface directly with the substrate 102. For example, the substrate 102 can be a package substrate, such as polymer package substrate. As an alternative to any or all of these examples, an interposer can be disposed between the PIC 116 and the substrate 102. The interposer can include some or all of the electrical connections to the substrate 102 of FIGS. 1 and 2 and can attach to a substrate as needed. For the purposes of this document, the term substrate can include a package substrate, and can optionally include an interposer disposed between the package substrate and the PIC 116.

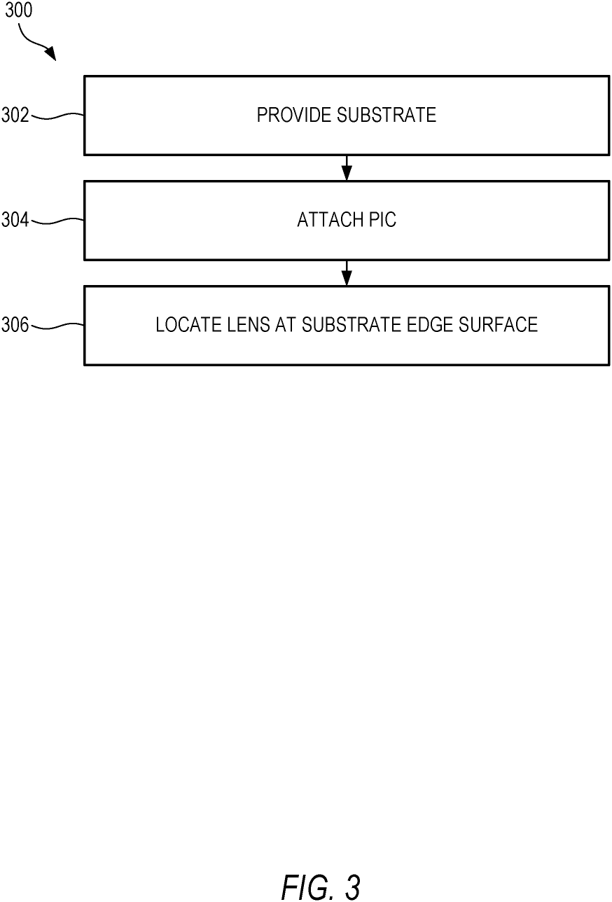

FIG. 3 shows a flow chart of an example of a method 300 for assembling an optical circuit, in accordance with some embodiments. The method 300 can be executed to assemble the optical circuits 100, 200 shown in FIGS. 1 or 2, or to assemble other suitable optical circuits. Other methods of assembly can also be used.

At operation 302, a substrate can be provided. The substrate can have a substrate top surface, a substrate bottom surface opposite the substrate top surface, and a substrate edge surface that extends around at least a portion of a perimeter of the substrate between the substrate top surface and the substrate bottom surface.

At operation 304, a photonic integrated circuit (PIC) can be attached to the substrate. The PIC can have a PIC optical port that is configured to accept or emit an optical beam along a PIC optical axis.

At operation 306, a lens can be located at the substrate edge surface. The substrate can include an optical path that extends through the substrate from a first substrate optical port that is aligned with the PIC optical axis to a second substrate optical port that faces the lens, such that an optical beam emergent from the PIC optical port traverses the optical path and passes through the lens to emerge substantially parallel to the substrate top surface.

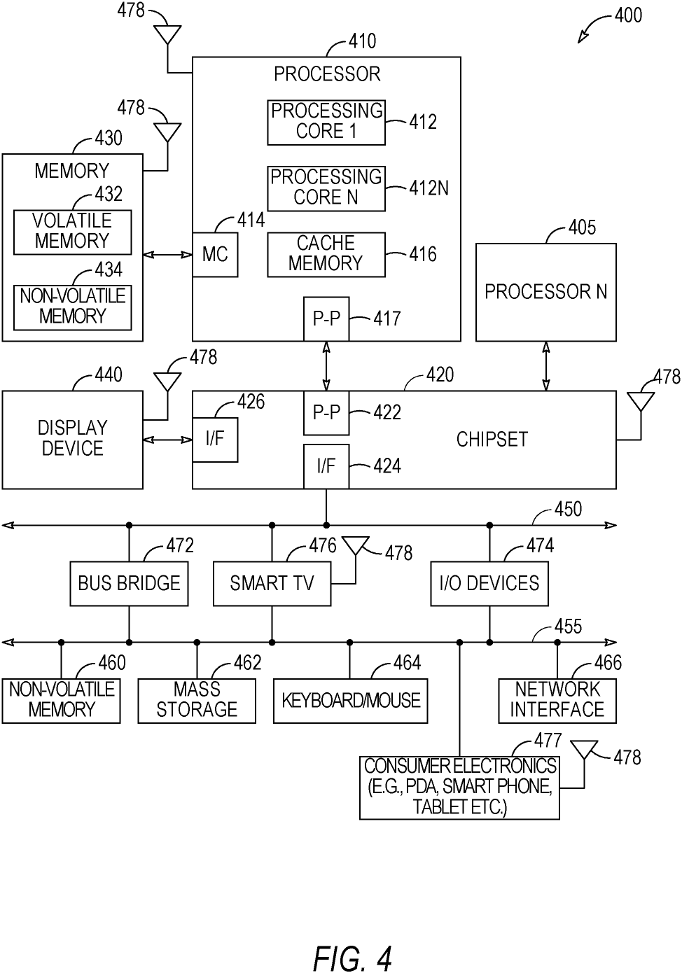

FIG. 4 shows a system level diagram, depicting an example of an electronic device (e.g., system) that may include an optical circuit (such as 100 or 200) and/or methods described above. In one embodiment, system 400 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In some embodiments, system 400 includes a system on a chip (SOC) system.

In one embodiment, processor 410 has one or more processor cores 412 and 412N, where 412N represents the Nth processor core inside processor 410 where N is a positive integer. In one embodiment, system 400 includes multiple processors including 410 and 405, where processor 405 has logic similar or identical to the logic of processor 410. In some embodiments, processing core 412 includes, but is not limited to, pre-fetch logic to fetch instructions, decode logic to decode the instructions, execution logic to execute instructions and the like. In some embodiments, processor 410 has a cache memory 416 to cache instructions and/or data for system 400. Cache memory 416 may be organized into a hierarchal structure including one or more levels of cache memory.

In some embodiments, processor 410 includes a memory controller 414, which is operable to perform functions that enable the processor 410 to access and communicate with memory 430 that includes a volatile memory 432 and/or a non-volatile memory 434. In some embodiments, processor 410 is coupled with memory 430 and chipset 420. Processor 410 may also be coupled to a wireless antenna 478 to communicate with any device configured to transmit and/or receive wireless signals. In one embodiment, an interface for wireless antenna 478 operates in accordance with, but is not limited to, the IEEE 802.11 standard and its related family, Home Plug AV (HPAV), Ultra-Wide Band (UWB), Bluetooth, WiMax, or any form of wireless communication protocol.

In some embodiments, volatile memory 432 includes, but is not limited to, Synchronous Dynamic Random-Access Memory (SDRAM), Dynamic Random Access Memory (DRAM), RAMBUS Dynamic Random Access Memory (RDRAM), and/or any other type of random access memory device. Non-volatile memory 434 includes, but is not limited to, flash memory, phase change memory (PCM), read-only memory (ROM), electrically erasable programmable read-only memory (EEPROM), or any other type of non-volatile memory device.

Memory 430 stores information and instructions to be executed by processor 410. In one embodiment, memory 430 may also store temporary variables or other intermediate information while processor 410 is executing instructions. In the illustrated embodiment, chipset 420 connects with processor 410 via Point-to-Point (PtP or P-P) interfaces 417 and 422. Chipset 420 enables processor 410 to connect to other elements in system 400. In some embodiments of the example system, interfaces 417 and 422 operate in accordance with a PtP communication protocol such as the Intel® QuickPath Interconnect (QPI) or the like. In other embodiments, a different interconnect may be used.

In some embodiments, chipset 420 is operable to communicate with processor 410, 405N, display device 440, and other devices, including a bus bridge 472, a smart TV 476, I/O devices 474, nonvolatile memory 460, a storage medium (such as one or more mass storage devices) 462, a keyboard/mouse 464, a network interface 466, and various forms of consumer electronics 477 (such as a PDA, smart phone, tablet etc.), etc. In one embodiment, chipset 420 couples with these devices through an interface 424. Chipset 420 may also be coupled to a wireless antenna 478 to communicate with any device configured to transmit and/or receive wireless signals. In one example, any combination of components in a chipset may be separated by a continuous flexible shield as described in the present disclosure.

Chipset 420 connects to display device 440 via interface 426. Display 440 may be, for example, a liquid crystal display (LCD), a light emitting diode (LED) array, an organic light emitting diode (OLED) array, or any other form of visual display device. In some embodiments of the example system, processor 410 and chipset 420 are merged into a single SOC. In addition, chipset 420 connects to one or more buses 450 and 455 that interconnect various system elements, such as I/O devices 474, nonvolatile memory 460, storage medium 462, a keyboard/mouse 464, and network interface 466. Buses 450 and 455 may be interconnected together via a bus bridge 472.

In one embodiment, mass storage device 462 includes, but is not limited to, a solid-state drive, a hard disk drive, a universal serial bus flash memory drive, or any other form of computer data storage medium. In one embodiment, network interface 466 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra-Wide Band (UWB), Bluetooth, WiMax, or any form of wireless communication protocol.

While the modules shown in FIG. 4 are depicted as separate blocks within the system 400, the functions performed by some of these blocks may be integrated within a single semiconductor circuit or may be implemented using two or more separate integrated circuits. For example, although cache memory 416 is depicted as a separate block within processor 410, cache memory 416 (or selected aspects of 416) can be incorporated into processor core 412.

To better illustrate the method and apparatuses disclosed herein, a non-limiting list of embodiments is provided here:

Example 1 includes an optical circuit, comprising: a substrate having a substrate top surface, a substrate bottom surface opposite the substrate top surface, and a substrate edge surface that extends around at least a portion of a perimeter of the substrate between the substrate top surface and the substrate bottom surface; a photonic integrated circuit (PIC) attached to the substrate, the PIC having a PIC optical port that is configured to accept or emit an optical beam along a PIC optical axis; and a lens located at the substrate edge surface, the substrate including an optical path that extends through the substrate from a first substrate optical port that is aligned with the PIC optical axis to a second substrate optical port that faces the lens, such that an optical beam emergent from the PIC optical port traverses the optical path and passes through the lens to emerge substantially parallel to the substrate top surface.

In Example 2, the optical circuit of Example 1 can optionally be configured such that the lens has a curved surface configured to collimate light that emerges from the optical path of the substrate or focus collimated light into the optical path of the substrate.

In Example 3, the optical circuit of any one of Examples 1-2 can optionally be configured such that the curved surface has a central axis that is collinear with at least a portion of the optical path.

In Example 4, the optical circuit of any one of Examples 1-3 can optionally be configured such that the curved surface has a central axis that is substantially parallel to the substrate top surface.

In Example 5, the optical circuit of any one of Examples 1-4 can optionally be configured such that: the PIC is attached to the substrate top surface; and the lens is located on the substrate top surface proximate the substrate edge surface.

In Example 6, the optical circuit of any one of Examples 1-5 can optionally be configured such that: the lens includes a lens reference surface that contacts the substrate top surface; and the optical beam emergent from the PIC optical port traverses the optical path and enters the lens through the lens reference surface.

In Example 7, the optical circuit of any one of Examples 1-6 can optionally be configured such that the lens includes a facet that is configured to reflect light inside the lens via total internal reflection.

In Example 8, the optical circuit of any one of Examples 1-7 can optionally be configured such that: the substrate top surface defines a top surface plane; and the lens is located on only one side of the top surface plane.

In Example 9, the optical circuit of any one of Examples 1-8 can optionally be configured such that the lens is located on the substrate edge surface.

In Example 10, the optical circuit of any one of Examples 1-9 can optionally be configured such that: the substrate edge surface includes a substrate ledge that is parallel to the substrate top surface; and the lens includes a lens reference surface that contacts the substrate ledge.

In Example 11, the optical circuit of any one of Examples 1-10 can optionally be configured such that: the substrate top surface defines a top surface plane; the substrate bottom surface defines a bottom surface plane; the substrate ledge is located between the top surface plane and the bottom surface plane.

In Example 12, the optical circuit of any one of Examples 1-11 can optionally be configured such that: the substrate top surface defines a top surface plane; the substrate bottom surface defines a bottom surface plane; and the lens is located only between the top surface plane and the bottom surface plane.

In Example 13, the optical circuit of any one of Examples 1-12 can optionally be configured such that: the substrate comprises a substrate material; and the lens comprises a lens material different from the substrate material.

In Example 14, the optical circuit of any one of Examples 1-13 can optionally be configured such that: the PIC is attached to the substrate top surface; the first substrate optical port is located on the substrate top surface; the PIC has a PIC bottom surface that electrically contacts the substrate top surface; and the PIC optical port is located on the PIC bottom surface.

In Example 15, the optical circuit of any one of Examples 1-14 can optionally be configured such that the PIC is a first PIC, the PIC optical port is a first PIC optical port, and the PIC optical axis is a first PIC optical axis; further comprising a second PIC attached to the substrate, the second PIC having a second PIC optical port that is configured to accept or emit a second optical beam along a second PIC optical axis, the substrate further including an optical path branch that extends through the substrate from a third substrate optical port aligned with the second PIC optical axis to the optical path, such that a second optical beam emergent from the second PIC optical port traverses the optical path branch and a portion of the optical path and passes through the lens to emerge substantially parallel to the substrate top surface.

In Example 16, the optical circuit of any one of Examples 1-15 can optionally further include an index-matching material disposed between the first substrate optical port and the PIC optical port, the index-matching material configured to reduce reflections at an interface between the PIC and the substrate.

Example 17 is a method for assembling an optical circuit, the method comprising: providing a substrate having a substrate top surface, a substrate bottom surface opposite the substrate top surface, and a substrate edge surface that extends around at least a portion of a perimeter of the substrate between the substrate top surface and the substrate bottom surface; attaching a photonic integrated circuit (PIC) to the substrate, the PIC having a PIC optical port that is configured to accept or emit an optical beam along a PIC optical axis; and locating a lens at the substrate edge surface, the substrate including an optical path that extends through the substrate from a first substrate optical port that is aligned with the PIC optical axis to a second substrate optical port that faces the lens, such that an optical beam emergent from the PIC optical port traverses the optical path and passes through the lens to emerge substantially parallel to the substrate top surface.

In Example 18, the method of Example 17 can optionally further include: positioning a refractive index-matching material between the first substrate optical port and the PIC optical port to reduce reflections at an interface between the PIC and the substrate.

Example 19 is an optical circuit, comprising: a substrate having a substrate top surface, a substrate bottom surface opposite the substrate top surface, and a substrate edge surface that extends around at least a portion of a perimeter of the substrate between the substrate top surface and the substrate bottom surface, the substrate comprising a substrate material; a photonic integrated circuit (PIC) attached to the substrate, the PIC having a PIC optical port that is configured to accept or emit an optical beam along a PIC optical axis; and a lens located at the substrate edge surface, the substrate including an optical path that extends through the substrate from a first substrate optical port that is aligned with the PIC optical axis to a second substrate optical port that faces the lens, such that an optical beam emergent from the PIC optical port traverses the optical path and passes through the lens to emerge substantially parallel to the substrate top surface, the lens comprising a lens material that is different from the substrate material, the lens including a lateral surface that is parallel to the substrate edge surface.

In Example 20, the optical circuit of Example 19 can optionally further include an index-matching material disposed between the first substrate optical port and the PIC optical port, the index-matching material configured to reduce reflections at an interface between the PIC and the substrate.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term "if' may be construed to mean "when" or "upon" or "in response to determining" or "in response to detecting," depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. An optical circuit, comprising:
a substrate having a substrate top surface, a substrate bottom surface opposite the substrate top surface, and a substrate edge surface that extends around at least a portion of a perimeter of the substrate between the substrate top surface and the substrate bottom surface;
a photonic integrated circuit (PIC) attached to the substrate, the PIC having a PIC optical port that is configured to accept or emit an optical beam along a PIC optical axis; and
a lens located at the substrate edge surface, the substrate including an optical path that extends through the substrate from a first substrate optical port that is aligned with the PIC optical axis to a second substrate optical port that faces the lens, such that an optical beam emergent from the PIC optical port traverses the optical path and passes through the lens to emerge substantially parallel to the substrate top surface.

2. The optical circuit of claim 1, wherein the lens has a curved surface configured to collimate light that emerges from the optical path of the substrate or focus collimated light into the optical path of the substrate.

3. The optical circuit of claim 2, wherein the curved surface has a central axis that is collinear with at least a portion of the optical path.

4. The optical circuit of claim 2, wherein the curved surface has a central axis that is substantially parallel to the substrate top surface.

5. The optical circuit of claim 1, wherein:
the PIC is attached to the substrate top surface; and
the lens is located on the substrate top surface proximate the substrate edge surface.

6. The optical circuit of claim 5, wherein:
the lens includes a lens reference surface that contacts the substrate top surface; and
the optical beam emergent from the PIC optical port traverses the optical path and enters the lens through the lens reference surface.

7. The optical circuit of claim 1, wherein the lens includes a facet that is configured to reflect light inside the lens via total internal reflection.

8. The optical circuit of claim 1, wherein:
the substrate top surface defines a top surface plane; and
the lens is located on only one side of the top surface plane.

9. The optical circuit of claim 1, wherein the lens is located on the substrate edge surface.

10. The optical circuit of claim 9, wherein:
the substrate edge surface includes a substrate ledge that is parallel to the substrate top surface; and
the lens includes a lens reference surface that contacts the substrate ledge.

11. The optical circuit of claim 10, wherein:
the substrate top surface defines a top surface plane;
the substrate bottom surface defines a bottom surface plane; and
the substrate ledge is located between the top surface plane and the bottom surface plane.

12. The optical circuit of claim 1, wherein:
the substrate top surface defines a top surface plane;
the substrate bottom surface defines a bottom surface plane; and
the lens is located only between the top surface plane and the bottom surface plane.

13. The optical circuit of claim 1, wherein:
the substrate comprises a substrate material; and
the lens comprises a lens material different from the substrate material.

14. The optical circuit of claim 1, wherein:
the PIC is attached to the substrate top surface;
the first substrate optical port is located on the substrate top surface;
the PIC has a PIC bottom surface that electrically contacts the substrate top surface; and
the PIC optical port is located on the PIC bottom surface.

15. The optical circuit of claim 1,
wherein the PIC is a first PIC, the PIC optical port is a first PIC optical port, and the PIC optical axis is a first PIC optical axis;
further comprising a second PIC attached to the substrate, the second PIC having a second PIC optical port that is configured to accept or emit a second optical beam along a second PIC optical axis, the substrate further including an optical path branch that extends through the substrate from a third substrate optical port aligned with the second PIC optical axis to the optical path, such that a second optical beam emergent from the second PIC optical port traverses the optical path branch and a portion of the optical path and passes through the lens to emerge substantially parallel to the substrate top surface.

16. The optical circuit of claim 1, further comprising an index-matching material disposed between the first substrate optical port and the PIC optical port, the index-matching material configured to reduce reflections at an interface between the PIC and the substrate.

17. A method for assembling an optical circuit, the method comprising:
providing a substrate having a substrate top surface, a substrate bottom surface opposite the substrate top surface, and a substrate edge surface that extends around at least a portion of a perimeter of the substrate between the substrate top surface and the substrate bottom surface;
attaching a photonic integrated circuit (PIC) to the substrate, the PIC having a PIC optical port that is configured to accept or emit an optical beam along a PIC optical axis; and
locating a lens at the substrate edge surface, the substrate including an optical path that extends through the substrate from a first substrate optical port that is aligned with the PIC optical axis to a second substrate optical port that faces the lens, such that an optical beam emergent from the PIC optical port traverses the optical path and passes through the lens to emerge substantially parallel to the substrate top surface.

18. The method of claim 17, further comprising:
positioning a refractive index-matching material between the first substrate optical port and the PIC optical port to reduce reflections at an interface between the PIC and the substrate.

19. An optical circuit, comprising:
a substrate having a substrate top surface, a substrate bottom surface opposite the substrate top surface, and a substrate edge surface that extends around at least a portion of a perimeter of the substrate between the substrate top surface and the substrate bottom surface, the substrate comprising a substrate material;
a photonic integrated circuit (PIC) attached to the substrate, the PIC having a PIC optical port that is configured to accept or emit an optical beam along a PIC optical axis; and
a lens located at the substrate edge surface, the substrate including an optical path that extends through the substrate from a first substrate optical port that is aligned with the PIC optical axis to a second substrate optical port that faces the lens, such that an optical beam emergent from the PIC optical port traverses the optical path and passes through the lens to emerge substantially parallel to the substrate top surface, the lens comprising a lens material that is different from the substrate material, the lens including a lateral surface that is parallel to the substrate edge surface.

20. The optical circuit of claim 19, further comprising an index-matching material disposed between the first substrate optical port and the PIC optical port, the index-matching material configured to reduce reflections at an interface between the PIC and the substrate.
